(19) United States
(12) Patent Application Publication
(10) Pub. No.: US 2025/0301242 A1
(43) Pub. Date: Sep. 25, 2025

(54) IMAGING DEVICE AND CHARGE PUMP CIRCUIT

(71) Applicant: Sony Semiconductor Solutions Corporation, Kanagawa (JP)

(72) Inventor: Tamon Miyazako, Kanagawa (JP)

(21) Appl. No.: 18/869,165

(22) PCT Filed: May 9, 2023
(86) PCT No.: PCT/JP2023/017450

§ 371 Date: Nov. 25, 2024

(30) Foreign Application Priority Data
Jun. 20, 2022 (JP) 2022-098964

(51) Int. Cl. H04N 25/779; H02M 3/07

(52) U.S. Cl. CPC H04N 25/779; H02M 3/07

(57) ABSTRACT

Imaging devices and charge pump circuits are disclosed. In one example, an imaging device includes a light receiving element, a pixel transistor, and a charge pump circuit. The charge pump circuit includes a pulse generation circuit that generates a first pulse signal, a pulse transmission circuit that generates a second pulse signal by changing a voltage range of the first pulse signal, and a switching circuit that outputs, as a drive voltage, a negative voltage or a positive voltage higher than a power supply voltage by performing a switching operation on the basis of the second pulse signal.

### TECHNICAL FIELD

The present disclosure relates to an imaging device and a charge pump circuit.

### BACKGROUND ART

An imaging device represented by a CMOS image sensor or the like generally includes a light receiving element that photoelectrically converts incident light, a pixel transistor for detecting a charge photoelectrically converted by the light receiving element, and the like. In such an imaging device, when the pixel transistor is driven, there is a case where a negative voltage or a positive voltage higher than a power supply voltage is required. In such a case, the imaging device is provided with a charge pump circuit that generates the negative voltage or the positive voltage.

A conventional charge pump circuit is provided with a level shifter in order to output the negative voltage. The level shifter changes the amplitude of a pulse signal to the negative voltage side. Therefore, a reference voltage generation circuit that generates a reference voltage lower than the power supply voltage is required in the charge pump circuit. The reference voltage generation circuit hinders downsizing of the charge pump circuit.

### CITATION LIST

### Patent Document

Patent Document 1: Japanese Patent Application Laid-Open No. 2006-319684

### SUMMARY OF THE INVENTION

### Problems to be Solved by the Invention

The present disclosure provides an imaging device and a charge pump circuit that can be downsized.

### Solutions to Problems

An imaging device of the present disclosure includes: a light receiving element that photoelectrically converts incident light; a pixel transistor that detects a charge photoelectrically converted by the light receiving element; and a charge pump circuit that supplies a drive voltage of the pixel transistor. The charge pump circuit includes: a pulse generation circuit that generates a first pulse signal; a pulse transmission circuit that generates a second pulse signal obtained by changing a voltage range of the first pulse signal input from the pulse generation circuit; and a switching circuit that outputs, as the drive voltage, a negative voltage or a positive voltage higher than a power supply voltage by performing a switching operation on the basis of the second pulse signal input from the pulse transmission circuit. The pulse transmission circuit includes: a pulse input terminal to which the first pulse signal is input; a pulse output terminal that outputs the second pulse signal; a first inverter element connected to the pulse input terminal; a capacitive element having one end connected to an output side of the first inverter element and another end connected to the pulse output terminal; and a first switching element connected to the another end of the capacitive element.

In a case where the drive voltage is the negative voltage, the pixel transistor may be a transfer transistor that transfers the charge to a floating diffusion layer, or may be a selection transistor that selects whether or not to output a pixel signal generated in the floating diffusion layer.

In a case where the drive voltage is the positive voltage, the pixel transistor may be a reset transistor that initializes a potential of a floating diffusion layer.

A charge pump circuit of the present disclosure includes: a pulse generation circuit that generates a first pulse signal; a pulse transmission circuit that generates a second pulse signal obtained by changing a voltage range of the first pulse signal input from the pulse generation circuit; and a switching circuit that outputs a negative voltage or a positive voltage higher than a power supply voltage by performing a switching operation on the basis of the second pulse signal input from the pulse transmission circuit. The pulse transmission circuit includes: a pulse input terminal to which the first pulse signal is input; a pulse output terminal that outputs the second pulse signal; a first inverter element connected to the pulse input terminal; a capacitive element having one end connected to an output side of the first inverter element and another end connected to the output terminal; and a first switching element connected to the another end of the capacitive element.

The first switching element may be grounded.

The first switching element may be connected to a power supply line having a potential of the power supply voltage.

The pulse transmission circuit may further include a second inverter element connected to the output side of the first inverter element, and a second switching element connected to an output side of the second inverter element and to the first switching element, and the second switching element may be driven on the basis of an output signal of the first inverter element.

The first switching element may include a P-channel MOS transistor, and
the second switching element may include an N-channel MOS transistor.

The pulse transmission circuit may further include a third switching element connected in parallel with the second switching element.

The first switching element and the third switching element may each include a P-channel MOS transistor, and
the second switching element may include an N-channel MOS transistor.

The pulse transmission circuit may further include: a resistance element connected to the pulse output terminal; a fourth switching element connected in series to the resistance element; and a fifth switching element connected in series to the resistance element and the fourth switching element.

The fourth switching element and the fifth switching element may each include a P-channel MOS transistor.

The charge pump circuit may further include a feedback circuit that feeds back an output voltage of the switching circuit.

### BRIEF DESCRIPTION OF DRAWINGS

FIG. 1 is a block diagram illustrating a configuration example of an imaging device according to a first embodiment.

FIG. 2 is a diagram illustrating an example of a circuit configuration of a pixel.

FIG. 3 is a diagram illustrating an example of a circuit configuration of a charge pump circuit according to the first embodiment.

FIG. 4 is a diagram illustrating an example of a circuit configuration of a pulse transmission circuit.

FIG. 5A is a diagram illustrating a state of a first pulse transmission circuit when a first pulse signal is at a high level.

FIG. 5B is a diagram illustrating a state of the first pulse transmission circuit when the first pulse signal is at a low level.

FIG. 6 is a timing chart for describing an operation of a switching circuit.

FIG. 7 is a diagram illustrating a configuration of a charge pump circuit according to a comparative example.

FIG. 8 is a diagram illustrating a circuit configuration of a level shifter according to the comparative example.

FIG. 9 is a diagram illustrating a circuit configuration of a pulse transmission circuit according to a modification.

FIG. 10 is a diagram illustrating a circuit configuration of a second pulse transmission circuit according to a second embodiment.

FIG. 11 is a diagram illustrating voltage waveforms in the charge pump circuit of the first embodiment.

FIG. 12 is a diagram illustrating voltage waveforms in a charge pump circuit of the second embodiment.

FIG. 13 is a diagram illustrating a circuit configuration of a second pulse transmission circuit according to a third embodiment.

FIG. 14 is a diagram illustrating a circuit configuration of a second pulse transmission circuit according to a fourth embodiment.

FIG. 15 is a block diagram illustrating an example of a schematic configuration of a vehicle control system.

FIG. 16 is an explanatory view illustrating an example of installation positions of an outside-vehicle information detecting section and an imaging section.

### MODE FOR CARRYING OUT THE INVENTION

### First Embodiment

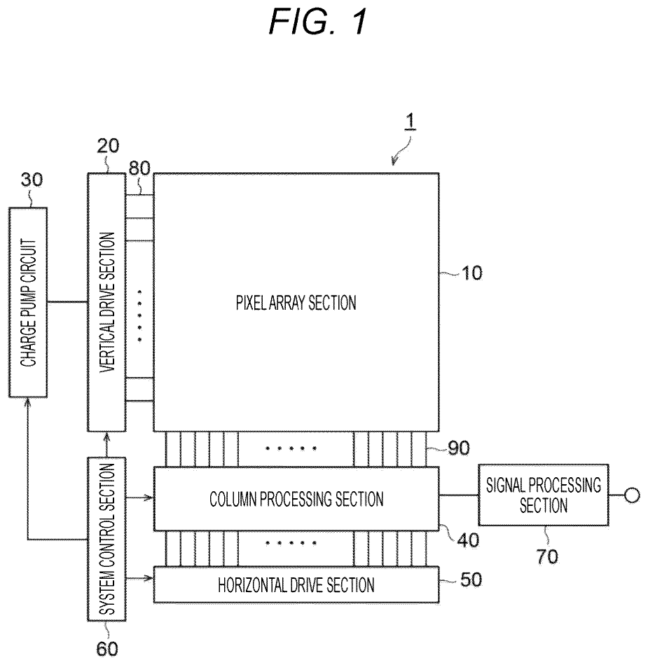

FIG. 1 is a block diagram illustrating a configuration example of an imaging device according to a first embodiment. An imaging device 1 illustrated in FIG. 1 is a CMOS image sensor including a pixel array section 10, a vertical drive section 20, a charge pump circuit 30, a column processing section 40, a horizontal drive section 50, a system control section 60, and a signal processing section 70.

In the pixel array section 10, a plurality of pixels is two-dimensionally arranged in a matrix. Each of the pixels generates and outputs a pixel signal indicating a charge amount corresponding to the amount of incident light. A circuit configuration of the pixel will be described later. Furthermore, in the pixel array section 10, a pixel drive line 80 is connected to each pixel row and a vertical signal line 90 is connected to each pixel column.

The vertical drive section 20 includes a shift register, an address decoder, and the like, and drives each pixel of the pixel array section 10 in units of row, for example. One end of the pixel drive line 80 is connected to an output end of the vertical drive section 20 corresponding to each pixel row.

The charge pump circuit 30 generates a negative voltage or a positive voltage higher than a power supply voltage. The negative voltage or the positive voltage is supplied from the vertical drive section 20 to each pixel through the pixel drive line 80. A circuit configuration of the charge pump circuit 30 will also be described later.

The column processing section 40 includes a signal processing circuit for each pixel column of the pixel array section 10. Each signal processing circuit of the column processing section 40 performs noise removal processing such as correlated double sampling (CDS) processing and signal processing such as analog/digital (A/D) conversion processing on the pixel signal output from each pixel of the selected row through the vertical signal line 90. The column processing section 40 temporarily holds the pixel signal subjected to the signal processing.

The horizontal drive section 50 includes a shift register, an address decoder, and the like, and sequentially selects the signal processing circuit of the column processing section 40. According to the selective scanning by the horizontal drive section 50, the pixel signals subjected to the signal processing by the respective signal processing circuits of the column processing section 40 are sequentially output to the signal processing section 70.

The system control section 60 includes a timing generator that generates various timing signals, and the like, and controls the vertical drive section 20, the charge pump circuit 30, the column processing section 40, and the horizontal drive section 50 on the basis of the various timing signals generated by the timing generator.

The signal processing section 70 includes at least an addition processing function. The signal processing section 70 performs various types of signal processing such as addition processing on the pixel signals output from the column processing section 40. Furthermore, the signal processing section 70 outputs the pixel signals subjected to the signal processing.

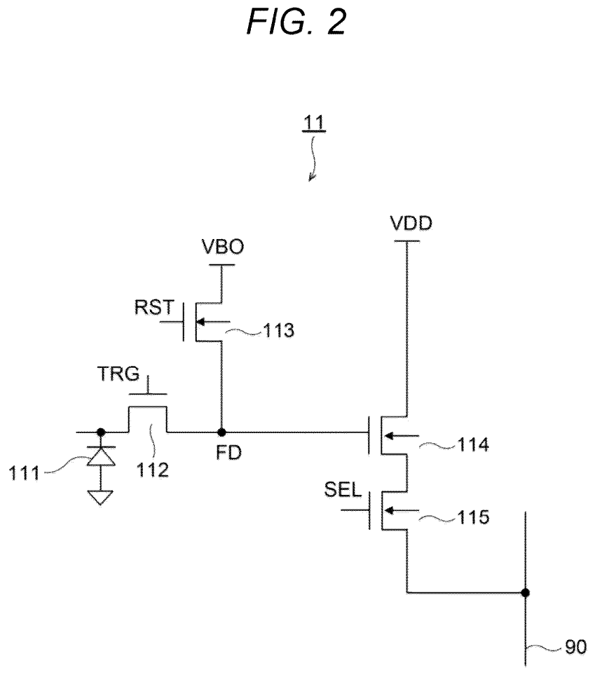

FIG. 2 is a diagram illustrating an example of a circuit configuration of the pixel. A pixel 11 illustrated in FIG. 2 includes a light receiving element 111, a transfer transistor 112, a reset transistor 113, an amplifier transistor 114, and a selection transistor 115. The transfer transistor 112, the reset transistor 113, and the selection transistor 115 correspond to pixel transistors for detecting a charge photoelectrically converted by the light receiving element 111. Furthermore, in the present embodiment, the transfer transistor 112, the reset transistor 113, the amplifier transistor 114, and the selection transistor 115 each include an N-channel MOS transistor.

The light receiving element 111 includes, for example, a photodiode that photoelectrically converts incident light to generate a charge. An anode of the light receiving element 111 is grounded to the ground. A cathode of the light receiving element 111 is connected to the transfer transistor 112.

The transfer transistor 112 transfers the charge from the light receiving element 111 to a floating diffusion layer FD in accordance with a transfer signal TRG input from the vertical drive section 20 to a gate through the pixel drive line 80. The floating diffusion layer FD accumulates the charge and generates a pixel signal indicated by a voltage corresponding to the charge amount. A drain of the transfer transistor 112 is connected to the cathode of the light receiving element 111, and a source of the transfer transistor 112 is connected to the floating diffusion layer FD.

The reset transistor 113 extracts the charge from the floating diffusion layer FD in accordance with a reset signal RST input from the vertical drive section 20 to the gate through the pixel drive line 80. As a result, a potential of the floating diffusion layer FD is initialized (reset). A drain of the reset transistor 113 is connected to a wiring having a potential of a positive voltage VBO, and a source of the reset transistor 113 is connected to the floating diffusion layer FD. The potential of the positive voltage VBO is the same as a power supply voltage VDD or higher than the power supply voltage VDD.

The amplifier transistor 114 amplifies the voltage of the pixel signal generated in the floating diffusion layer FD. A gate of the amplifier transistor 114 is connected to the floating diffusion layer FD. A drain is connected to a power supply line having a potential of the power supply voltage VDD. A source is connected to a drain of the selection transistor 115.

The selection transistor 115 selects whether or not to output the pixel signal amplified by the amplifier transistor 114 to the vertical signal line 90 in accordance with a selection signal SEL input from the vertical drive section 20 to the gate through the pixel drive line 80.

In the imaging device 1 configured as described above, the vertical drive section 20 supplies a high-level reset signal RST and a high-level transfer signal TRG to the pixel 11 at the start of exposure. As a result, the light receiving element 111 is initialized.

Subsequently, the vertical drive section 20 supplies the high-level reset signal RST over a pulse period for the pixel 11 immediately before the end of exposure. As a result, the potential of the floating diffusion layer FD is initialized. Thereafter, the vertical drive section 20 supplies the high-level transfer signal TRG over the pulse period for the pixel 11 at the end of exposure. As a result, a signal charge corresponding to the exposure amount is transferred to the floating diffusion layer FD, and a pixel signal corresponding to the voltage level of the floating diffusion layer FD at that time is generated.

Note that the circuit configuration of the pixel 11 is not limited to the example illustrated in FIG. 2. In addition, also a method for driving the pixels 11 may be a global shutter method in which exposure is performed for all the pixels 11 simultaneously, or a rolling shutter method in which exposure is performed for each pixel row or each pixel column.

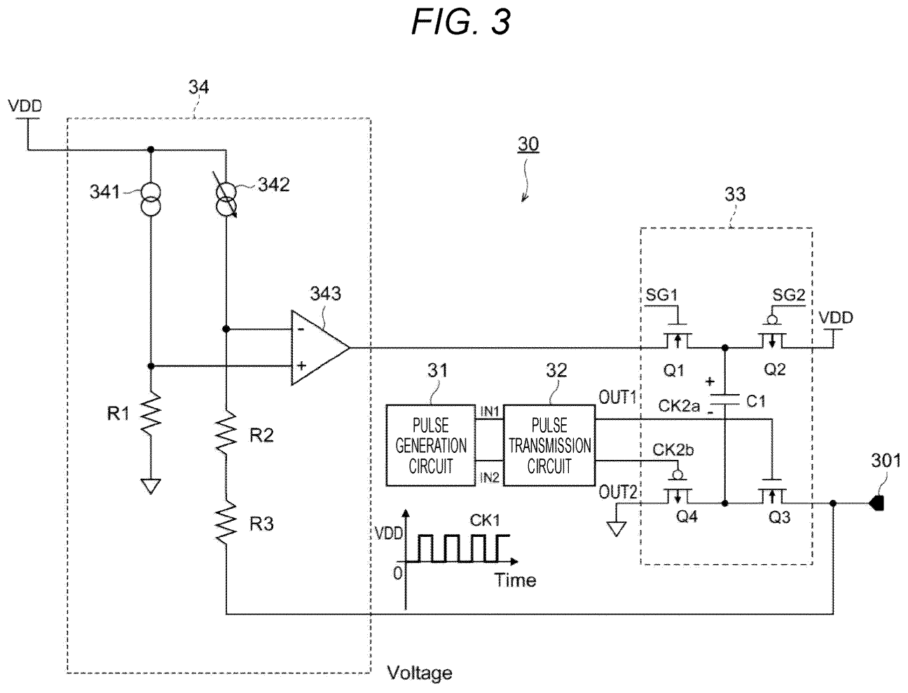

FIG. 3 is a diagram illustrating an example of the circuit configuration of the charge pump circuit 30 according to the first embodiment. The charge pump circuit 30 according to the present embodiment includes a pulse generation circuit 31, a pulse transmission circuit 32, a switching circuit 33, and a feedback circuit 34.

The pulse generation circuit 31 generates a first pulse signal CK1 having a fixed frequency. The pulse generation circuit 31 can be implemented by, for example, a ring oscillation circuit, an unstable multivibrator circuit, a blocking oscillation circuit, or the like.

The pulse transmission circuit 32 changes a voltage range so that the minimum voltage value (low-level voltage value) and the maximum voltage value (high-level voltage value) of the first pulse signal CK1 input from the pulse generation circuit 31 change. For example, in a case where the first pulse signal CK1 has a voltage range in which the minimum voltage value is set to 0 V and the maximum voltage value is set to the power supply voltage VDD, the pulse transmission circuit 32 changes the voltage range of the first pulse signal CK1 to a voltage range in which the minimum voltage value is set to a negative voltage Vn and the maximum voltage value is set to a positive voltage Vp.

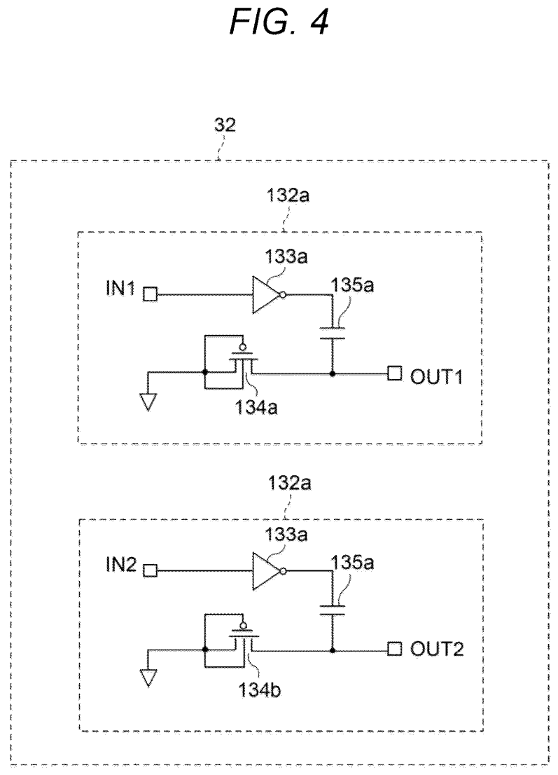

FIG. 4 is a diagram illustrating an example of a circuit configuration of the pulse transmission circuit 32. The pulse transmission circuit 32 illustrated in FIG. 4 includes a first pulse transmission circuit 132a and a second pulse transmission circuit 132b.

The first pulse transmission circuit 132a includes a first pulse input terminal IN1, a first pulse output terminal OUT1, a first inverter element 133a, a first switching element 134a, and a capacitive element 135a. The first switching element 134a includes a P-channel MOS transistor.

The first pulse input terminal IN1 is connected to an input side of the first inverter element 133a. One end of the capacitive element 135a is connected to an output side of the first inverter element 133a. The other end of the capacitive element 135a is connected to the first pulse output terminal OUT1 and to a drain of the first switching element 134a. A source of the first switching element 134a is grounded while being connected to a gate.

The second pulse transmission circuit 132b includes a second pulse input terminal IN2, a second pulse output terminal OUT2, a first inverter element 133b, a first switching element 134b, and a capacitive element 135b. Since a circuit configuration of the second pulse transmission circuit 132b is the same as the circuit configuration of the first inverter element 133a, the description thereof will be omitted.

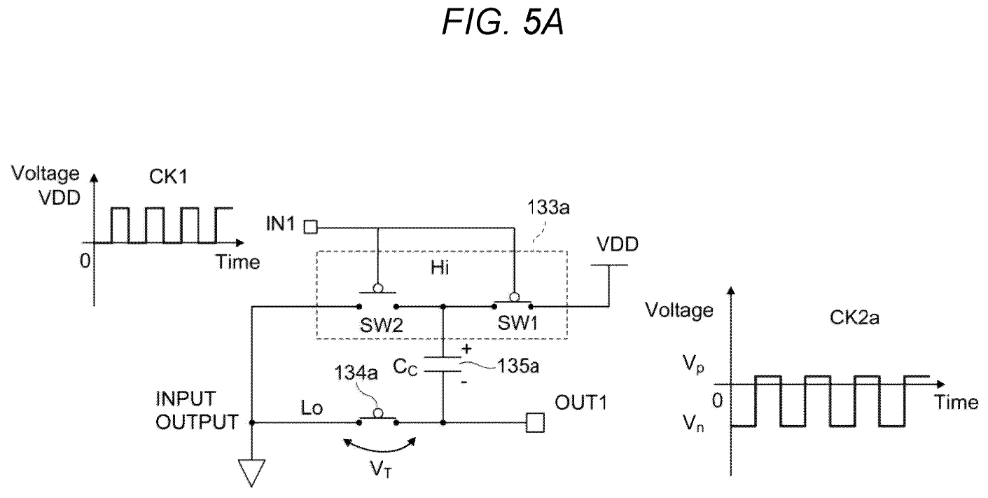

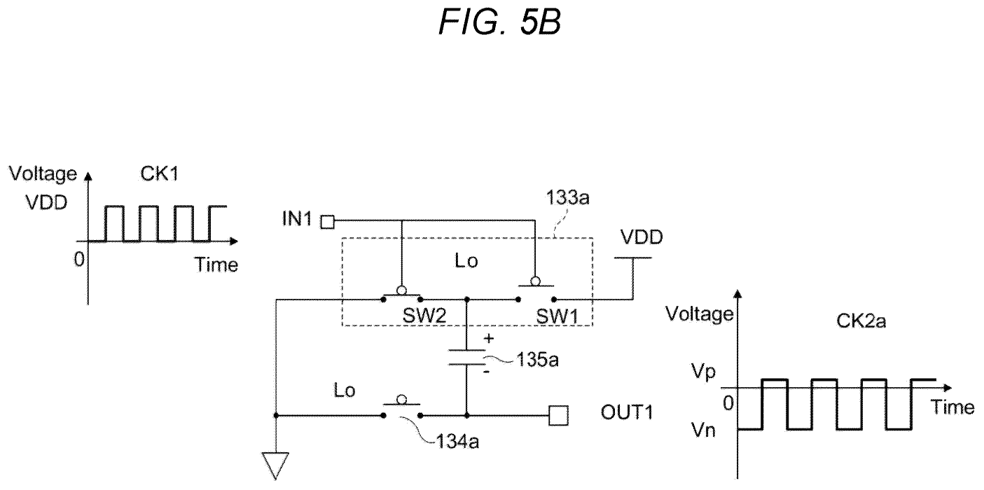

Hereinafter, the operation of the pulse transmission circuit 32 will be described with reference to FIGS. 5A and 5B. The operation of the first pulse transmission circuit 132a is the same as the operation of the second pulse transmission circuit 132b. Therefore, the operation of the first pulse transmission circuit 132a will be described here.

FIG. 5A is a diagram illustrating a state of the first pulse transmission circuit 132a when the first pulse signal CK1 is at a high level. FIG. 5B is a diagram illustrating a state of the first pulse transmission circuit 132a when the first pulse signal CK1 is at a low level. As illustrated in FIGS. 5A and 5B, the first inverter element 133a is equivalent to a circuit including a switching element SW1 and a switching element SW2 connected in series between a power supply line having a potential of the power supply voltage VDD and a ground line having a ground potential.

As illustrated in FIG. 5A, when the first pulse signal CK1 is at a high level, the switching element SW1 is turned on, the switching element SW2 is turned off, and the first switching element 134a is turned on. In this case, in the capacitive element 135a, the potential at one end is the power supply voltage VDD, and the potential at the other end is the ground potential. Thereby, the capacitive element 135a enters a charged state. As a result, a voltage V_{OUT} at the first pulse output terminal OUT1 becomes a positive voltage Vp.

On the other hand, as illustrated in FIG. 5B, when the first pulse signal CK1 is at a low level, the switching element SW1 is turned off, the switching element SW2 is turned on, and the first switching element 134a is turned off. In this case, in the capacitive element 135a, the potential at one end is the ground potential, and the potential at the other end is the negative potential. As a result, the voltage V_{OUT} at the first pulse output terminal OUT1 becomes a negative voltage Vn (for example, −2.0 V).

Note that the voltage V_{OUT} can be calculated by the following Formula (1).

$$\begin{matrix}[ Mathematical Formula 1 ] & \\ {V}_{XLSOUT} = \frac{{C}_{c}}{{C}_{c} + {C}_{L}} \times ( VDD - {V}_{T} ) & ( 1 )\end{matrix}$$

In the above Formula (1), C_{C} is a capacitance value of the capacitive element 135a. In addition, C_{L} is an input capacitance of the MOS transistor connected to the output terminal OUT. Furthermore, V_{T} is a loss voltage (drain-source voltage) at the first switching element 134a.

As described above, in the pulse transmission circuit 32, the first pulse signal CK1 is converted into a second pulse signal CK2a having a voltage range in which the minimum voltage value is the negative voltage Vn and the maximum voltage value is the positive voltage Vp. The second pulse signal CK2a is input to the switching circuit 33.

Returning to FIG. 3, the switching circuit 33 includes a first switch Q1, a second switch Q2, a third switch Q3, a fourth switch Q4, and a capacitor C1. In the present embodiment, the first switch Q1 and the third switch Q3 are N-channel MOS transistors. In addition, the second switch Q2 and the fourth switch Q4 are P-channel MOS transistors.

The first switch Q1 and the second switch Q2 are connected in series between the power supply line having a potential of the power supply voltage VDD and the feedback circuit 34. Specifically, a source of the second switch Q2 is connected to the power supply line described above, and a source of the first switch Q1 is connected to the feedback circuit 34. The first switch Q1 is turned on or off on the basis of a first drive signal SG1 input from the system control section 60 to a gate. On the other hand, the second switch Q2 is turned on or off on the basis of a second drive signal SG2 input from the system control section 60 to a gate.

The third switch Q3 and the fourth switch Q4 are connected in series between an output terminal 301 of the charge pump circuit 30 and a ground line having a ground potential. Specifically, a source of the third switch Q3 is connected to the output terminal 301, and a source of the fourth switch Q4 is connected to the ground line described above. The third switch Q3 is turned on or off on the basis of the second pulse signal CK2a input from the first pulse transmission circuit 132a (see FIG. 4). On the other hand, the fourth switch Q4 is turned on or off on the basis of a second pulse signal CK2b input from the second pulse transmission circuit 132b (see FIG. 4).

The capacitor C1 is connected between a connection point between the first switch Q1 and the second switch Q2, and a connection point between the third switch Q3 and the fourth switch Q4. Specifically, one end of the capacitor C1 is connected to the drain of each of the first switch Q1 and the second switch Q2, and the other end is connected to the drain of each of the third switch Q3 and the fourth switch Q4.

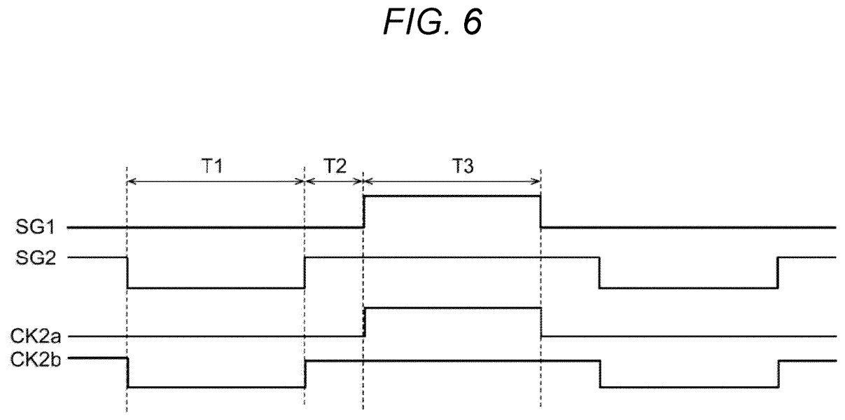

Hereinafter, the operation of the switching circuit 33 described above will be described with reference to FIG. 6. FIG. 6 is a timing chart for describing the operation of the switching circuit 33. The timing chart in FIG. 6 indicates level changes of the first drive signal SG1 input to the gate of the first switch Q1, the second drive signal SG2 input to the gate of the second switch Q2, the second pulse signal CK2a input to a gate of the third switch Q3, and the second pulse signal CK2b input to a gate of the fourth switch Q4.

First, in a charge period T1, the first drive signal SG1, the second drive signal SG2, the second pulse signal CK2a, and the second pulse signal CK2b are all at the low level. Therefore, since the first switch Q1 and the third switch Q3 each include the N-channel MOS transistor, the first switch Q1 and the third switch Q3 are turned off. On the other hand, since the second switch Q2 and the fourth switch Q4 each include the P-channel MOS transistor, the second switch Q2 and the fourth switch Q4 are turned on. As a result, in the charge period T1, the capacitor C1 is connected to the power supply and the ground and charged.

Subsequently, in a disconnection period T2, while the first drive signal SG1 and the second pulse signal CK2a are at the low level, the second drive signal SG2 and the second pulse signal CK2b become the high level. Therefore, the first switch Q1 to the fourth switch Q4 are all turned off. As a result, the capacitor C1 is disconnected from the power supply and the ground.

Finally, in a discharge period T3, the second drive signal SG2 and the second pulse signal CK2b maintain the high level, and the first drive signal SG1 and the second pulse signal CK2a also become the high level. Therefore, the first switch Q1 and the third switch Q3 are turned on, while the second switch Q2 and the fourth switch Q4 are turned off. As a result, since the charge accumulated in the capacitor C1 is discharged, the potential of the output terminal 301 becomes a negative voltage. The negative voltage is used as, for example, a gate drive voltage for turning off the transfer transistor 112 and the selection transistor 115. At this time, the output voltage of the output terminal 301 is fed back to the feedback circuit 34.

Returning to FIG. 3, the feedback circuit 34 includes a current source 341, a variable current source 342, an operational amplifier 343, a resistance element R1, a resistance element R2, and a resistance element R3. Note that the current source 342 may be a variable current source.

The resistance element R1 is connected in series to the current source 341. The resistance element R2 and the resistance element R3 are connected in series to the variable current source 342. Furthermore, one end of the resistance element R3 is connected to the output terminal 301.

A reference voltage is set by the current supplied from the current source 341 and a resistance value of the resistance element R1. The reference voltage is input to a non-inverting input terminal (+) of the operational amplifier 343. In addition, a voltage obtained by dividing the output voltage of the output terminal 301 by the resistance element R2 and the resistance element R3 is input to an inverting input terminal (−) of the operational amplifier 343. The output terminal of the operational amplifier 343 outputs a voltage obtained by amplifying a difference between the voltage of the non-inverting input terminal (+) and the voltage of the inverting input terminal (−). In the feedback circuit 34, the operational amplifier 343 is driven so that the respective voltages input to the non-inverting input terminal (+) and the inverting input terminal (−) become the same, and thus the output voltage of the charge pump circuit 30 can be stabilized.

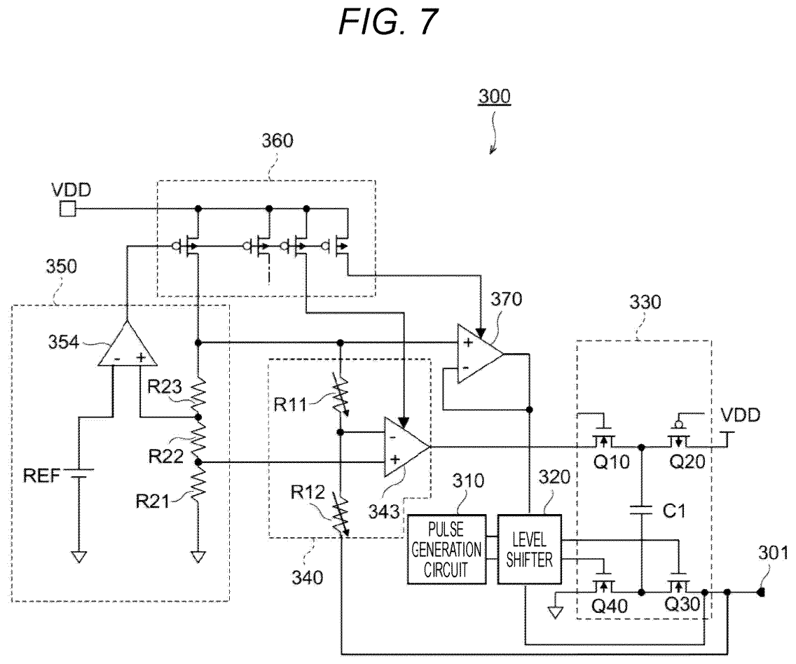

FIG. 7 is a diagram illustrating a configuration of a charge pump circuit according to a comparative example. A charge pump circuit 300 illustrated in FIG. 7 includes a pulse generation circuit 310, a level shifter 320, a switching circuit 330, a feedback circuit 340, a reference voltage source 350, a current mirror circuit 360, and a voltage follower 370.

The pulse generation circuit 310 generates a pulse signal having a fixed frequency, similarly to the pulse generation circuit 31 described above.

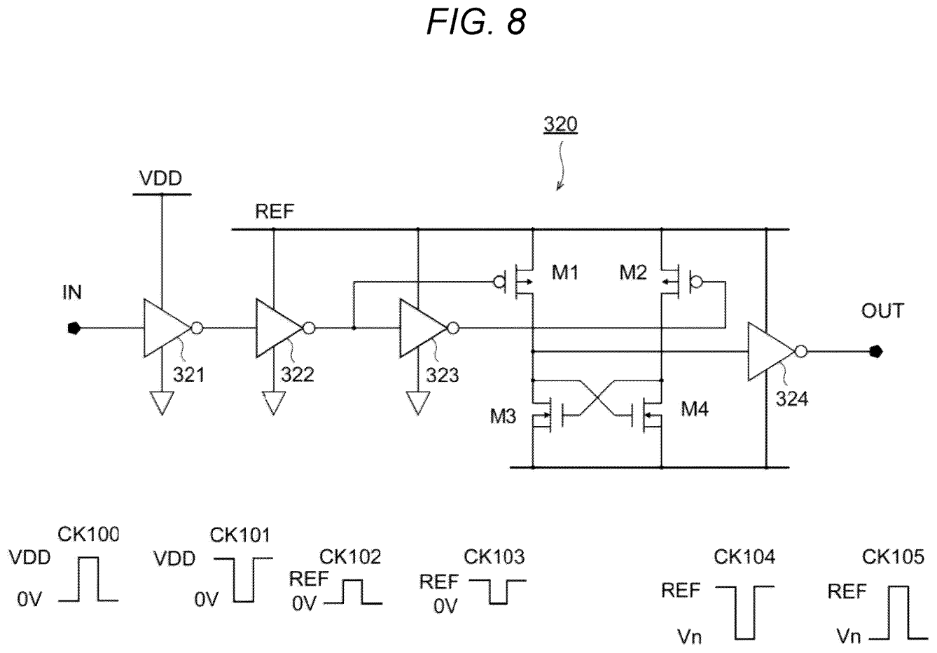

The level shifter 320 changes an amplitude range of the pulse signal input from the pulse generation circuit 310. Here, a circuit configuration of the level shifter 320 will be described with reference to FIG. 8.

FIG. 8 is a diagram illustrating a circuit configuration of the level shifter 320 according to the comparative example. The level shifter 320 includes four inverter elements 321 to 324 and four transistors M1 to M4. In the level shifter 320, a voltage range of a pulse signal CK100 input from the pulse generation circuit 310 is in a range of 0 V to a power supply voltage VDD. The pulse signal CK100 is inverted by the inverter element 321. An inverted pulse signal CK101 is further inverted by the inverter element 322 arranged at the subsequent stage of the inverter element 321. At this time, a voltage range of an inverted pulse signal CK102 is limited to 0 V to a reference voltage REF. The reference voltage REF is a positive voltage lower than the power supply voltage VDD.

The pulse signal CK102 described above is inverted by the inverter element 323 arranged at the subsequent stage of the inverter element 322. An inverted pulse signal CK103 is converted, by the transistors M1 to M4, into a pulse signal CK104 having a voltage range from a negative voltage Vn to the reference voltage REF. The pulse signal CK104 is inverted by a second inverter element 136b. Finally, an inverted pulse signal CK105 is output from an output terminal OUT. The output terminal OUT is connected to the switching circuit 330.

Returning to FIG. 7, the switching circuit 330 includes a first switch Q10, a second switch Q20, a third switch Q30, a fourth switch Q40, and a capacitor C1. The first switch Q10 and the second switch Q20 correspond to the first switch Q1 and the second switch Q2 of the switching circuit 33 described above, respectively. In addition, the third switch Q30 and the fourth switch Q40 correspond to the third switch Q3 and the fourth switch Q4 of the switching circuit 33, respectively. However, the fourth switch Q40 is different from the fourth switch Q4 in that the fourth switch Q4 is an N-channel MOS transistor.

In the switching circuit 330 configured as described above, the first switch Q10 and the second switch Q20 are turned on or off on the basis of drive signals input from a system control section 60 to respective gates. On the other hand, the third switch Q30 and the fourth switch Q40 are turned on or off on the basis of pulse signals input from the level shifter 320 to respective gates.

The capacitor C1 can be charged and discharged by performing a switching operation on the first switch Q10 to the fourth switch Q40 similarly to the first switch Q1 to the fourth switch Q4 of the switching circuit 33. An output voltage of an output terminal 301 is fed back to the feedback circuit 340.

The feedback circuit 340 includes a variable resistance element R11, a variable resistance element R12, and an operational amplifier 343. The variable resistance element R11 and the variable resistance element R12 divide the output voltage of the output terminal 301. The divided voltage is input to an inverting input terminal (−) of the operational amplifier 343. A reference voltage REF generated by the reference voltage source 350 is input to a non-inverting input terminal (+) of the operational amplifier 343. The operational amplifier 343 is driven so that the voltage input to the inverting input terminal (−) and the voltage input to the non-inverting input terminal (+) become the same. Therefore, the output voltage of the charge pump circuit 300 can be stabilized.

The reference voltage source 350 includes resistance elements R21 to R23 and an operational amplifier 354. The resistance elements R21 to R23 are connected in series. A connection point between the resistance element R21 and the resistance element R22 is connected to the non-inverting input terminal (+) of the operational amplifier 343 of the feedback circuit 340. A connection point between the resistance element R22 and the resistance element R23 is connected to a non-inverting input terminal (+) of the operational amplifier 354.

The potential of the inverting input terminal (−) of the operational amplifier 354 is set to the reference voltage REF. The operational amplifier operational amplifier 354 is driven so that the voltage input to the inverting input terminal (−) and the voltage input to the non-inverting input terminal (+) become the same, that is, the reference voltage REF is output.

The current mirror circuit 360 distributes the reference voltage REF generated by the reference voltage source 350 to the operational amplifier 343 of the feedback circuit 340 and the voltage follower 370. The voltage follower 370 supplies the reference voltage REF to the level shifter 320.

The charge pump circuit 300 configured as described above is provided with the level shifter 320 that generates a pulse signal of a negative voltage. Therefore, the reference voltage source 350 that generates the reference voltage REF lower than the power supply voltage VDD, and the voltage follower 370 that supplies the reference voltage REF to the level shifter 320 are required in the charge pump circuit 300.

On the other hand, the pulse transmission circuit 32 in the charge pump circuit 30 according to the present embodiment is not a level shifter as described above. Therefore, the reference voltage source 350 and the voltage follower 370 are not required. As a result, the charge pump circuit 30 can be downsized than the charge pump circuit 300 according to the comparative example. Specifically, the plane area of the charge pump circuit 300 can be reduced by about 54% in design with respect to the plane area of the charge pump circuit 300.

In addition, in the charge pump circuit 30, there is no power consumed by the reference voltage source 350 and the voltage follower 370. Therefore, it is also possible to reduce the power consumption of the charge pump circuit 30.

### (Modification)

Hereinafter, a modification of the first embodiment will be described. In the present modification, a circuit configuration of a pulse transmission circuit 32 is different from that of the first embodiment.

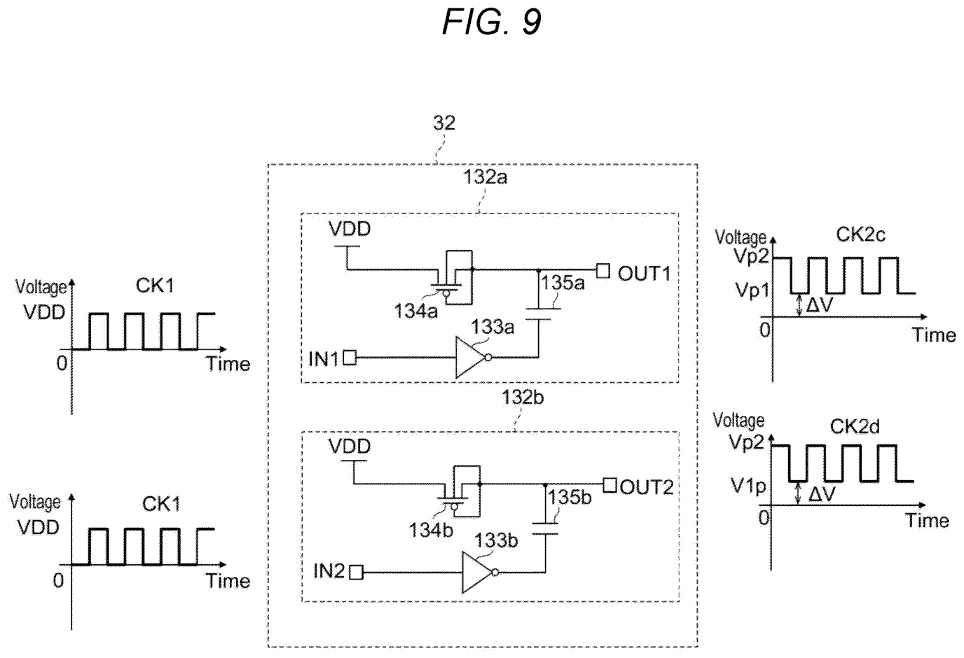

FIG. 9 is a diagram illustrating the circuit configuration of the pulse transmission circuit 32 according to the modification. Components similar to those of the first embodiment described above are denoted by the same reference numerals, and detailed description thereof will be omitted.

Also in the present modification, similarly to the first embodiment, the pulse transmission circuit 32 includes a first pulse transmission circuit 132a and a second pulse transmission circuit 132b. However, in the present modification, sources of the first switching element 134a and the first switching element 134b are each connected to a power supply line having a potential of a power supply voltage VDD.

In the pulse transmission circuit 32 of the present modification configured as described above, first pulse signals CK1 whose voltage range is set to 0 V to the power supply voltage VDD are each input from a pulse generation circuit 31 to a first pulse input terminal IN1 and to a second pulse input terminal IN2. At this time, when each circuit element of the pulse transmission circuit 32 is driven similarly to the first embodiment, as illustrated in FIG. 9, a second pulse signal CK2c and a second pulse signal CK2d whose voltage range is set to a positive voltage V1 to a positive voltage V2 are output from a first pulse output terminal OUT1 and a second output terminal OUT2, respectively. The positive voltage V1 is a voltage boosted by ΔV from 0 V. The positive voltage V2 is a voltage boosted by ΔV from the power supply voltage VDD.

The second pulse signal CK2c described above is input to a gate of a third switch Q3 of a switching circuit 33. In addition, the second pulse signal CK2d described above is input to a gate of a fourth switch Q4 of the switching circuit 33. The third switch Q3 performs the switching operation on the basis of the second pulse signal CK2c and the fourth switch Q4 performs the switching operation on the basis of the second pulse signal CK2d, thereby a positive voltage higher than the power supply voltage VDD can be output from an output terminal 301 of a charge pump circuit 30. The positive voltage is supplied to a reset transistor 113 illustrated in FIG. 2 as a positive voltage VBO, for example.

According to the present modification described above, the pulse transmission circuit 32 is not a level shifter, similarly to the first embodiment. Therefore, a reference voltage source 350 and a voltage follower 370 are not required. As a result, the charge pump circuit 30 according to the present modification can also be downsized. Furthermore, in the present modification, the charge pump circuit 30 can output a high voltage obtained by boosting the power supply voltage VDD.

### Second Embodiment

Hereinafter, a second embodiment will be described. In the present embodiment, a circuit configuration of a second pulse transmission circuit is different from that of the first embodiment.

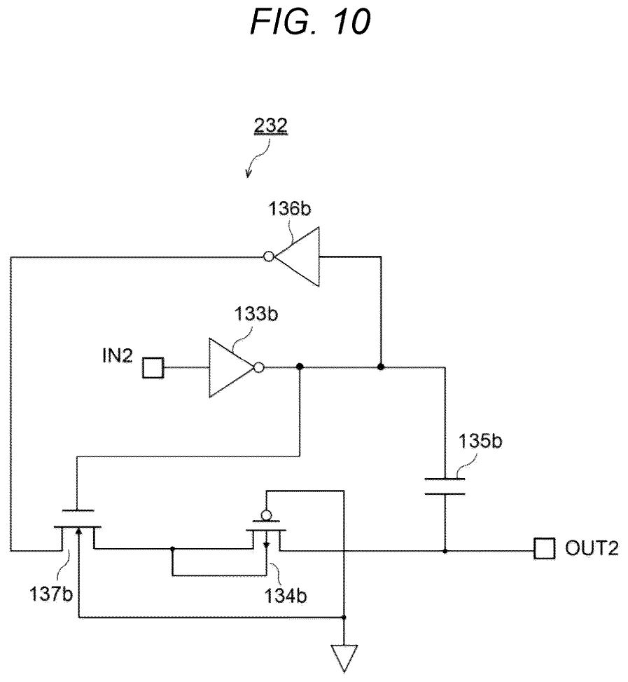

FIG. 10 is a diagram illustrating the circuit configuration of the second pulse transmission circuit according to the second embodiment. Note that the configuration of a first pulse transmission circuit connected to a gate of a third switch Q3 is only required to be the same as that of the first pulse transmission circuit 132a described in the first embodiment or a pulse transmission circuit 232 of the present embodiment described below.

The second pulse transmission circuit 232 according to the present embodiment includes a first inverter element 133b, a first switching element 134b, a capacitive element 135b, a second inverter element 136b, and a second switching element 137b. The pulse transmission circuit 232 is different from that of the first embodiment in including the second inverter element 136b and the second switching element 137b. The second switching element 137b includes an N-channel MOS transistor.

An input terminal of the second inverter element 136b is connected to an output terminal of the first inverter element 133b and one end of the capacitive element 135b. An output terminal of the second inverter element 136b is connected to a drain of the second switching element 137b. A source of the second switching element 137b is connected to a source and a body section of the first switching element 134a. A gate of the second switching element 137b is connected to an output terminal of the first inverter element 133b. A body section of the second switching element 137b is grounded together with a gate of the first switching element 134b. The second switching element 137b is driven on the basis of an output signal of the first inverter element 133b, specifically, a signal obtained by inverting the first pulse signal CK1 by the first inverter element 133b.

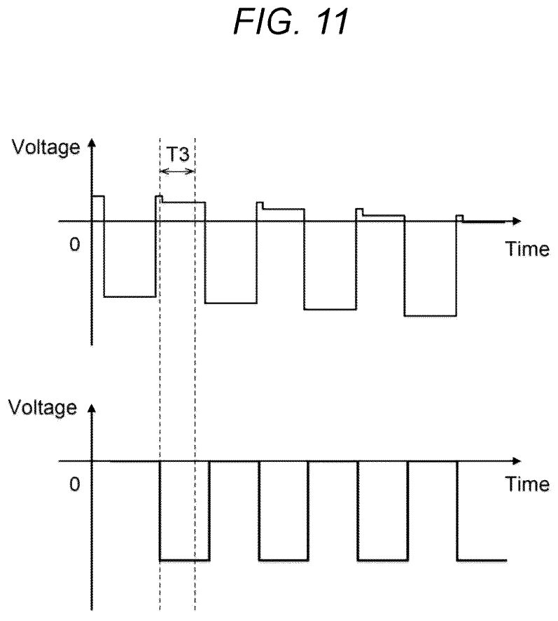

FIG. 11 is a diagram illustrating voltage waveforms in the charge pump circuit 30 of the first embodiment. The voltage waveform illustrated on the upper side of FIG. 11 is a waveform of the second pulse signal CK2b input from the second pulse transmission circuit 132b to the gate of the fourth switch Q4. On the other hand, the signal waveform illustrated on the lower side of FIG. 11 is a voltage waveform on the other end side of the capacitor C1 when the fourth switch Q4 performs the switching operation on the basis of the second pulse signal CK2b.

As illustrated in FIG. 11, when the second pulse signal CK2b becomes a high level, the fourth switch Q4 is turned off. As a result, the discharge period T3 for discharging the charge charged in the capacitor C1 starts, and the voltage of the other end of the capacitor C1 starts to change to a negative voltage. At this time, as illustrated in FIG. 11, the second pulse signal CK2b is pulled toward the negative side, and the high-level voltage value decreases. In this case, when the voltage value of the second pulse signal CK2b falls below the threshold, the fourth switch Q4 is turned on. As a result, the voltage waveform on the other end side of the capacitor C1 becomes unstable.

Therefore, the pulse transmission circuit 232 of the present embodiment is provided with the second inverter element 136b and the second switching element 137b. In the second switching element 137b, a voltage difference occurs between the source and the body section. As a result, a high-level voltage value of a second pulse signal CK2b becomes higher than that of the first embodiment.

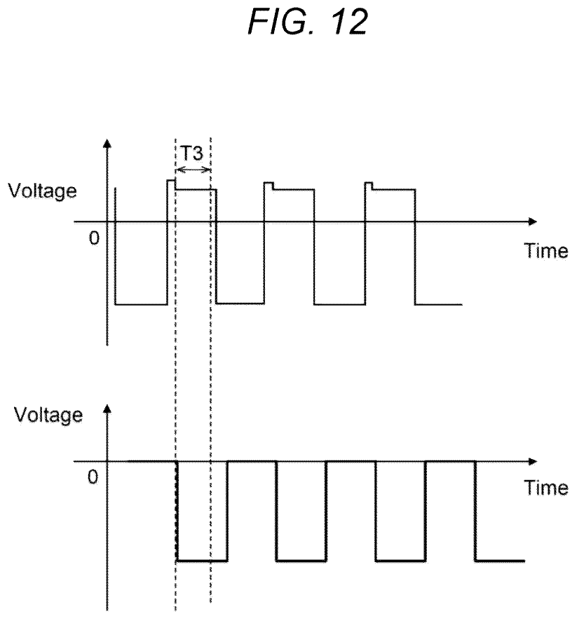

FIG. 12 is a diagram illustrating voltage waveforms in a charge pump circuit 30 of the second embodiment. The voltage waveform illustrated on the upper side of FIG. 12 is a waveform of the second pulse signal CK2b input from the pulse transmission circuit 232 to a gate of a fourth switch Q4. On the other hand, the signal waveform illustrated on the lower side of FIG. 12 is a voltage waveform on the other end side of a capacitor C1 when the fourth switch Q4 performs the switching operation on the basis of the second pulse signal CK2b.

Comparing FIGS. 11 and 12, the high-level voltage value of the second pulse signal CK2b is higher than that of the first embodiment. Specifically, the high-level voltage value is higher than that of the first embodiment by about 50 mV to 100 mV. Therefore, even if the second pulse signal CK2b is pulled toward the negative side by the voltage change of the voltage of the other end of the capacitor C1, the high-level voltage of the second pulse signal CK2b can be secured to a voltage sufficiently higher than the threshold described above. As a result, the off state of the fourth switch Q4 can be maintained in the charge period T3.

Therefore, according to the present embodiment, the voltage waveform on the other end side of the capacitor C1 can be stabilized. As a result, the output voltage of the charge pump circuit 30 is stabilized, and thus it becomes possible to stabilize the operations of the elements, for example, a transfer transistor 112 and a selection transistor 115, to which the voltage is supplied from the charge pump circuit 30.

### Third Embodiment

Hereinafter, a third embodiment will be described. In the present embodiment, a circuit configuration of a second pulse transmission circuit is different from that of the second embodiment.

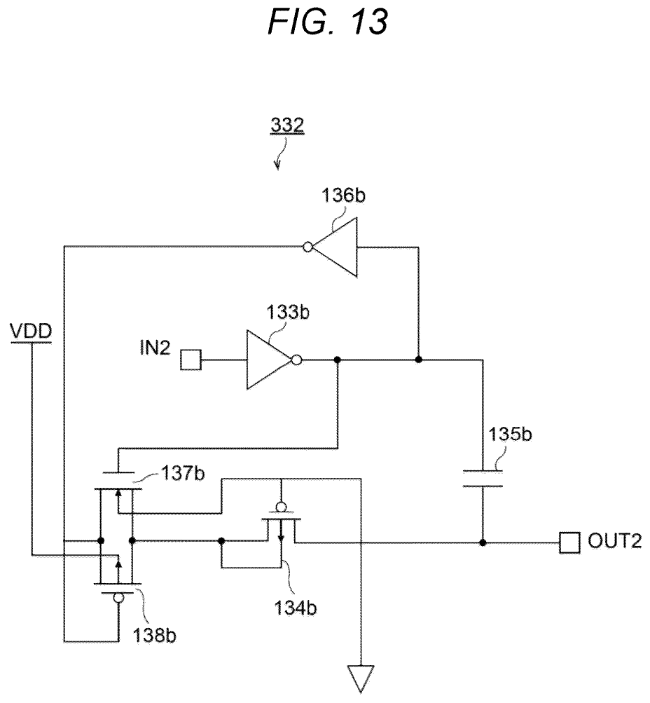

FIG. 13 is a diagram illustrating the circuit configuration of the second pulse transmission circuit according to the third embodiment. Note that the configuration of a first pulse transmission circuit connected to a gate of a third switch Q3 is only required to be the same as any of that of the first pulse transmission circuit 132a described in the first embodiment, the second pulse transmission circuit 232 described in the second embodiment, or a second pulse transmission circuit 332 of the present embodiment described below.

The second pulse transmission circuit 332 according to the present embodiment includes a first inverter element 133b, a first switching element 134b, a capacitive element 135b, a second inverter element 136b, a second switching element 137b, and a third switching element 138b. The pulse transmission circuit 332 is different from that of the second embodiment in including the third switching element 138b. The third switching element 138b includes a P-channel MOS transistor.

The third switching element 138b is connected in parallel with the second switching element 137b. Specifically, a drain of the third switching element 138b is connected to an output terminal of the second inverter element 136b in common with a drain of the second switching element 137b. In addition, a source of the third switching element 138b is grounded in common with a source of the second switching element 137b. A gate of the third switching element 138b is connected to the output terminal of the second inverter element 136b. The potential of a body section of the third switching element 138b is a power supply voltage VDD. The third switching element 138b is driven on the basis of an output signal of the second inverter element 136b, specifically, a signal obtained by inverting an output signal of the first inverter element 133b by the second inverter element 136b.

The pulse transmission circuit 332 of the present embodiment configured as described above is provided with the third switching element 138b. In the third switching element 138b, a voltage difference occurs between the source and the body section. As a result, also in the present embodiment, similarly to the second embodiment, a high-level voltage value of a second pulse signal CK2b becomes higher than that of the first embodiment. Therefore, even if the second pulse signal CK2b is pulled toward the negative side by the voltage change of the voltage of the other end of a capacitor C1, the voltage of the second pulse signal CK2b can be secured to a voltage sufficiently higher than the threshold at which a fourth switch Q4 switches from the off state to the on state. As a result, the off state of the fourth switch Q4 can be maintained in a discharge period T3.

Therefore, also in the present embodiment, similarly to the second embodiment, the voltage waveform on the other end side of the capacitor C1 can be stabilized. As a result, the output voltage of a charge pump circuit 30 is stabilized, and thus it becomes possible to stabilize the operations of the elements, for example, a transfer transistor 112 and a selection transistor 115, to which the voltage is supplied from the charge pump circuit 30.

### Fourth Embodiment

Hereinafter, a fourth embodiment will be described. In the present embodiment, a circuit configuration of a second pulse transmission circuit is different from that of the first embodiment.

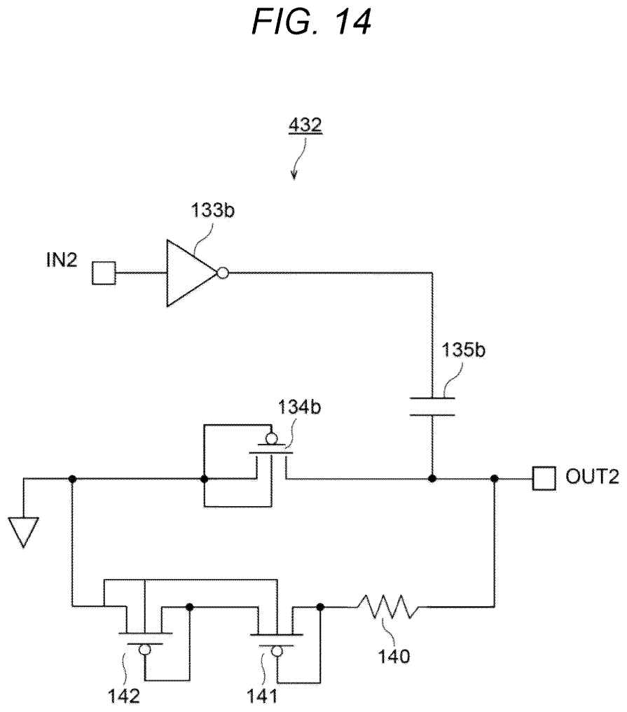

FIG. 14 is a diagram illustrating the circuit configuration of the second pulse transmission circuit according to the fourth embodiment. Note that the configuration of a first pulse transmission circuit connected to a gate of a third switch Q3 is only required to be the same as any of that of the first pulse transmission circuit 132a described in the first embodiment, the second pulse transmission circuit 232 described in the second embodiment, or the second pulse transmission circuit 332 described in the third embodiment.

A second pulse transmission circuit 432 according to the present embodiment includes a first inverter element 133b, a first switching element 134a, a capacitive element 135b, a resistance element 140, a fourth switching element 141, and a fifth switching element 142. The pulse transmission circuit 432 is different from that of the first embodiment in including the resistance element 140, the fourth switching element 141, and the fifth switching element 142. These are connected in series between a second pulse output terminal OUT2 and a ground line. That is, they are connected in parallel with the first switching element 134a. The fourth switching element 141 and the fifth switching element 142 each include a P-channel MOS transistor.

One end of the resistance element 140 is connected to the second pulse output terminal OUT2. The other end of the resistance element 140 is connected to a drain of the fourth switching element 141. The drain and a gate of the fourth switching element 141 are connected to each other. In addition, a source of the fourth switching element 141 is connected to a drain of the fifth switching element 142. Similarly to the fourth switching element 141, the drain of the fifth switching element 142 is also connected to the gate of the fifth switching element 142. Furthermore, a source of the fifth switching element 142 is grounded. Note that, instead of the resistance element 140, the fourth switching element 141, and the fifth switching element 142, the second pulse transmission circuit 432 according to the present embodiment may include the resistance element 140 and the fifth switching element 142 or may include the high-resistance element 140.

In the pulse transmission circuit 432 configured as described above, when the voltage of the other end of a capacitor C1 starts changing to a negative voltage in a discharge period T3, a part of the charge charged in the capacitor C1 is extracted through a current path including the resistance element R327, the fourth switching element 141, and the fifth switching element 142. Therefore, it is possible to suppress a decrease in the high-level voltage of the second pulse signal CK2b. Therefore, the voltage of the second pulse signal CK2b can be secured to a voltage sufficiently higher than the threshold at which a fourth switch Q4 switches from the off state to the on state. As a result, the off state of the fourth switch Q4 can be maintained in the discharge period T3.

Therefore, according to the present embodiment, the voltage waveform on the other end side of the capacitor C1 can be stabilized. As a result, the output voltage of a charge pump circuit 30 is stabilized, and thus it becomes possible to stabilize the operations of the elements, for example, a transfer transistor 112 and a selection transistor 115, to which the voltage is supplied from the charge pump circuit 30.

Note that, in each of the embodiments described above, the charge pump circuit 30 is provided in the imaging device 1. However, the application of the charge pump circuit 30 is not limited to the imaging device 1, and can be applied to a device including a drive element that requires a pulse signal of a negative voltage or a voltage higher than the power supply voltage VDD.

### <Application Example to Mobile Body>

The technology according to the present disclosure (the present technology) can be applied to various products. For example, the technology according to the present disclosure may be implemented as a device mounted on a mobile body of any kind, such as an automobile, an electric vehicle, a hybrid electric vehicle, a motorcycle, a bicycle, a personal mobility, an airplane, a drone, a vessel, or a robot.

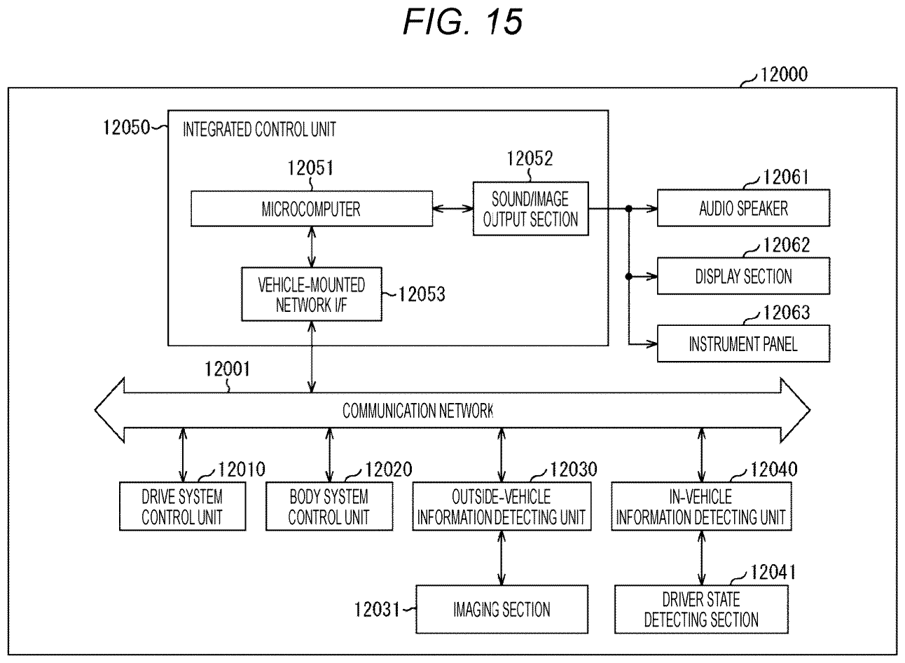

FIG. 15 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 15, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle such as an internal combustion engine or a driving motor, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device, which is capable of notifying a passenger of the vehicle or a person outside the vehicle of information visually or auditorily. In the example in FIG. 15, an audio speaker 12061, a display section 12062, and an instrument panel 12063 are illustrated as the output device. The display section 12062 may, for example, include at least one of an on-board display or a head-up display.

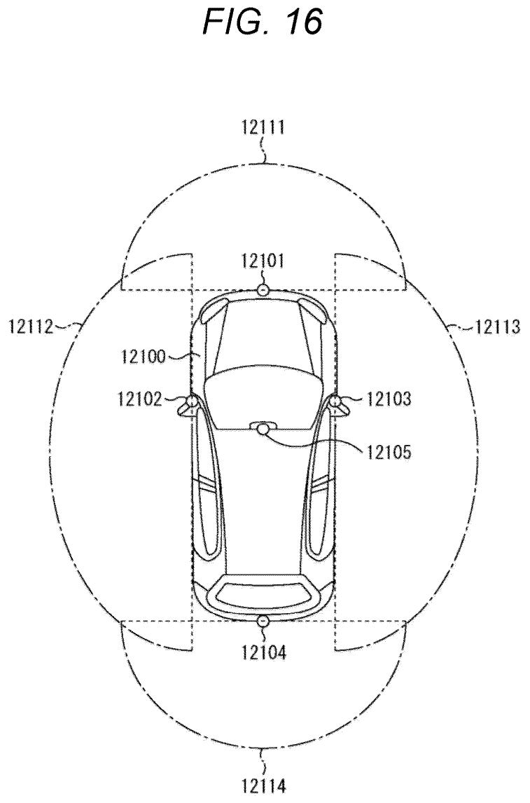

FIG. 16 is a view illustrating an example of the installation position of the imaging section 12031.

In FIG. 16, imaging sections 12101, 12102, 1210312104, and 12105 are included as the imaging section 12031.

The imaging sections 12101, 12102, 1210312104, and 12105 are provided, for example, at positions such as a front nose, a side mirror, a rear bumper, a back door, and an upper portion of a windshield within an interior of the vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 16 illustrates an example of photographing ranges of the imaging sections 12101 to 12104. An imaging range 12111 represents the imaging range of the imaging section 12101 provided to the front nose. Imaging ranges 1211212113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera including a plurality of imaging devices, or may be an imaging device including pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Furthermore, the microcomputer 12051 can set a following distance to be maintained in front of a preceding vehicle in advance, and perform automatic brake control (including following block control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure is applicable to, for example, the imaging sections 7910, 7912, 7914, 7916, and 7918 and the outside-vehicle information detecting sections 7920, 7922, 7924, 7926, 7928, and 7930 among the configurations described above. Moreover, in particular, since it is possible to realize downsizing and low power consumption of the imaging device, application of the technology according to the present disclosure can contribute to downsizing and low power consumption of the vehicle control system.

Note that the present technology can have the following configurations.

(1) An imaging device including:
a light receiving element that photoelectrically converts incident light;
a pixel transistor that detects a charge photoelectrically converted by the light receiving element; and
a charge pump circuit that supplies a drive voltage of the pixel transistor, in which
the charge pump circuit includes:
a pulse generation circuit that generates a first pulse signal;
a pulse transmission circuit that generates a second pulse signal obtained by changing a voltage range of the first pulse signal input from the pulse generation circuit; and
a switching circuit that outputs, as the drive voltage, a negative voltage or a positive voltage higher than a power supply voltage by performing a switching operation on the basis of the second pulse signal input from the pulse transmission circuit, and
the pulse transmission circuit includes: a pulse input terminal to which the first pulse signal is input; a pulse output terminal that outputs the second pulse signal; a first inverter element connected to the pulse input terminal; a capacitive element having one end connected to an output side of the first inverter element and another end connected to the pulse output terminal; and a first switching element connected to the another end of the capacitive element.

(2) The imaging device according to (1), in which in a case where the drive voltage is the negative voltage, the pixel transistor is a transfer transistor that transfers the charge to a floating diffusion layer, or is a selection transistor that selects whether or not to output a pixel signal generated in the floating diffusion layer.

(3) The imaging device according to (1), in which in a case where the drive voltage is the positive voltage, the pixel transistor is a reset transistor that initializes a potential of a floating diffusion layer.

(4) A charge pump circuit including:
a pulse generation circuit that generates a first pulse signal;
a pulse transmission circuit that generates a second pulse signal obtained by changing a voltage range of the first pulse signal input from the pulse generation circuit; and
a switching circuit that outputs a negative voltage or a positive voltage higher than a power supply voltage by performing a switching operation on the basis of the second pulse signal input from the pulse transmission circuit, in which
the pulse transmission circuit includes: a pulse input terminal to which the first pulse signal is input; a pulse output terminal that outputs the second pulse signal; a first inverter element connected to the pulse input terminal; a capacitive element having one end connected to an output side of the first inverter element and another end connected to the pulse output terminal; and a first switching element connected to the another end of the capacitive element.

(5) The charge pump circuit according to (4), in which the first switching element is grounded.

(6) The charge pump circuit according to (4), in which the first switching element is connected to a power supply line having a potential of the power supply voltage.

(7) The charge pump circuit according to (4), in which the pulse transmission circuit further includes a second inverter element connected to the output side of the first inverter element, and a second switching element connected to an output side of the second inverter element and to the first switching element, and the second switching element is driven on the basis of an output signal of the first inverter element.

(8) The charge pump circuit according to (7), in which
the first switching element includes a P-channel MOS transistor, and
the second switching element includes an N-channel MOS transistor.

(9) The charge pump circuit according to (7), in which the pulse transmission circuit further includes a third switching element connected in parallel with the second switching element.

(10) The charge pump circuit according to (9), in which
the first switching element and the third switching element each include a P-channel MOS transistor, and
the second switching element includes an N-channel MOS transistor.

(11) The charge pump circuit according to (4), in which the pulse transmission circuit further includes: a resistance element connected to the pulse output terminal; a fourth switching element connected in series to the resistance element; and a fifth switching element connected in series to the resistance element and the fourth switching element.

(12) The charge pump circuit according to (11), in which the fourth switching element and the fifth switching element each include a P-channel MOS transistor.

(13) The charge pump circuit according to any one of (4) to (12), further including a feedback circuit that feeds back an output voltage of the switching circuit.

### REFERENCE SIGNS LIST

1 Imaging device
11 Pixel
30 Charge pump circuit
31 Pulse generation circuit
32 Pulse transmission circuit
33 Switching circuit
34 Feedback circuit
111 Light receiving element
112 Transfer transistor
113 Reset transistor
115 Selection transistor
132a First pulse transmission circuit
132b Second pulse transmission circuit
133a, 133b First inverter element
134a, 134b First switching element
135a, 135b Capacitive element
136b Second inverter element
137b Second switching element
138b Third switching element
140 Resistance element
141 Fourth switching element
142 Fifth switching element
FD Floating diffusion layer

1. An imaging device comprising:
a light receiving element that photoelectrically converts incident light;
a pixel transistor that detects a charge photoelectrically converted by the light receiving element; and
a charge pump circuit that supplies a drive voltage of the pixel transistor, wherein
the charge pump circuit includes:
a pulse generation circuit that generates a first pulse signal;
a pulse transmission circuit that generates a second pulse signal obtained by changing a voltage range of the first pulse signal input from the pulse generation circuit; and
a switching circuit that outputs, as the drive voltage, a negative voltage or a positive voltage higher than a power supply voltage by performing a switching operation on a basis of the second pulse signal input from the pulse transmission circuit, and
the pulse transmission circuit includes: a pulse input terminal to which the first pulse signal is input; a pulse output terminal that outputs the second pulse signal; a first inverter element connected to the pulse input terminal; a capacitive element having one end connected to an output side of the first inverter element and another end connected to the pulse output terminal; and a first switching element connected to the another end of the capacitive element.

2. The imaging device according to claim 1, wherein in a case where the drive voltage is the negative voltage, the pixel transistor is a transfer transistor that transfers the charge to a floating diffusion layer, or is a selection transistor that selects whether or not to output a pixel signal generated in the floating diffusion layer.

3. The imaging device according to claim 1, wherein in a case where the drive voltage is the positive voltage, the pixel transistor is a reset transistor that initializes a potential of a floating diffusion layer.

4. A charge pump circuit comprising:
a pulse generation circuit that generates a first pulse signal;
a pulse transmission circuit that generates a second pulse signal obtained by changing a voltage range of the first pulse signal input from the pulse generation circuit; and
a switching circuit that outputs a negative voltage or a positive voltage higher than a power supply voltage by performing a switching operation on a basis of the second pulse signal input from the pulse transmission circuit, wherein
the pulse transmission circuit includes: a pulse input terminal to which the first pulse signal is input; a pulse output terminal that outputs the second pulse signal; a first inverter element connected to the pulse input terminal; a capacitive element having one end connected to an output side of the first inverter element and another end connected to the pulse output terminal; and a first switching element connected to the another end of the capacitive element.

5. The charge pump circuit according to claim 4, wherein the first switching element is grounded.

6. The charge pump circuit according to claim 4, wherein the first switching element is connected to a power supply line having a potential of the power supply voltage.

7. The charge pump circuit according to claim 4, wherein the pulse transmission circuit further includes a second inverter element connected to the output side of the first inverter element, and a second switching element connected to an output side of the second inverter element and to the first switching element, and the second switching element is driven on a basis of an output signal of the first inverter element.

8. The charge pump circuit according to claim 7, wherein
the first switching element includes a P-channel MOS transistor, and
the second switching element includes an N-channel MOS transistor.

9. The charge pump circuit according to claim 7, wherein
the pulse transmission circuit further includes a third switching element connected in parallel with the second switching element.

10. The charge pump circuit according to claim 9, wherein
the first switching element and the third switching element each include a P-channel MOS transistor, and
the second switching element includes an N-channel MOS transistor.

11. The charge pump circuit according to claim 4, wherein the pulse transmission circuit further includes: a resistance element connected to the pulse output terminal; a fourth switching element connected in series to the resistance element; and a fifth switching element connected in series to the resistance element and the fourth switching element.

12. The charge pump circuit according to claim 11, wherein the fourth switching element and the fifth switching element each include a P-channel MOS transistor.

13. The charge pump circuit according to claim 4, further comprising a feedback circuit that feeds back an output voltage of the switching circuit.
